(19) United States
(12) Patent Application Publication
(10) Pub. No.: US 2025/0321757 A1
(43) Pub. Date: Oct. 16, 2025

(54) AUTOMATED GENERATION OF DASHBOARDS AND ALARMS

(71) Applicant: Dell Products L.P., Round Rock, TX (US)

(72) Inventors: Kailash Nagarkoti, Redmond, WA (US); Anil Varkhedi, Bengaluru (IN); Sowmya Benakappa, Marysville, WA (US); Susmitha Pillarisetty, Hopkinton, MA (US)

(21) Appl. No.: 18/633,133

(22) Filed: Apr. 11, 2024

(51) Int. Cl. G06F 9/451; G06F 8/38

(52) U.S. Cl. CPC G06F 9/451; G06F 8/38

(57) ABSTRACT

Architectures and techniques are described that can automate generation of dashboards and alarms that are used to monitor the operation of microservices or other suitable entities. Threshold data can be determined for certain operational metrics of a microservices platform and stored to a data structure that can be configured or updated. Based on the threshold data, a template applicable to a particular observability application or service can be generated. The dashboard can be generated in response to inputting the template and the threshold data to the observability application or service.

### BACKGROUND

A microservices platform is a software architecture and set of tools designed to support the development, deployment, and management of microservices-based applications. Microservices architecture(s) generally enable an approach to software development where applications are composed of loosely coupled, independently deployable services, each responsible for a specific business function. Microservices platforms can provide developers with the tools and infrastructure needed to build, deploy, and operate microservices-based applications at scale. The platform can help organizations embrace the principles of microservices architecture and leverage associated benefits, such as agility, scalability, and resilience, to deliver innovative and reliable software solutions.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram 100 illustrating certain functionality or operation of a microservices platform in accordance with certain embodiments of this disclosure;

FIG. 2 depicts schematic block diagram illustrating an example architecture for creation of dashboards to monitor operation of microservices in accordance with certain embodiments of this disclosure;

FIG. 3 depicts a schematic block diagram illustrating an example device that can automatically and/or dynamically generate dashboards and alarms for microservices of a microservices platform in accordance with certain embodiments of this disclosure;

FIG. 4 depicts a schematic block diagram illustrating additional elements or embodiments relating to the generation of the dashboard in accordance with certain embodiments of this disclosure;

FIG. 5 depicts a schematic block diagram illustrating addition elements or embodiments relating to determining a custom metric in accordance with certain embodiments of this disclosure;

FIG. 6 depicts a schematic block diagram illustrating additional elements or embodiments relating to a device that can automate dynamic generate dashboards and alarms for microservices of a microservices platform in accordance with certain embodiments of this disclosure;

FIG. 7A depicts a schematic block diagram illustrating an example of the device being included in a microservices platform in accordance with certain embodiments of this disclosure;

FIG. 7B illustrates an example of device 300 being included in a build pipeline 702 in accordance with certain embodiments of this disclosure;

FIG. 8 illustrates an example method that can automatically and/or dynamically generate dashboards and alarms for microservices of a microservices platform in accordance with certain embodiments of this disclosure;

FIG. 9 illustrates an example method that can provide for additional functionality or elements relating to generating dashboards and alarms for microservices of a microservices platform in accordance with certain embodiments of this disclosure;

FIG. 10 illustrates a block diagram of an example distributed file storage system that employs tiered cloud storage in accordance with certain embodiments of this disclosure; and

FIG. 11 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

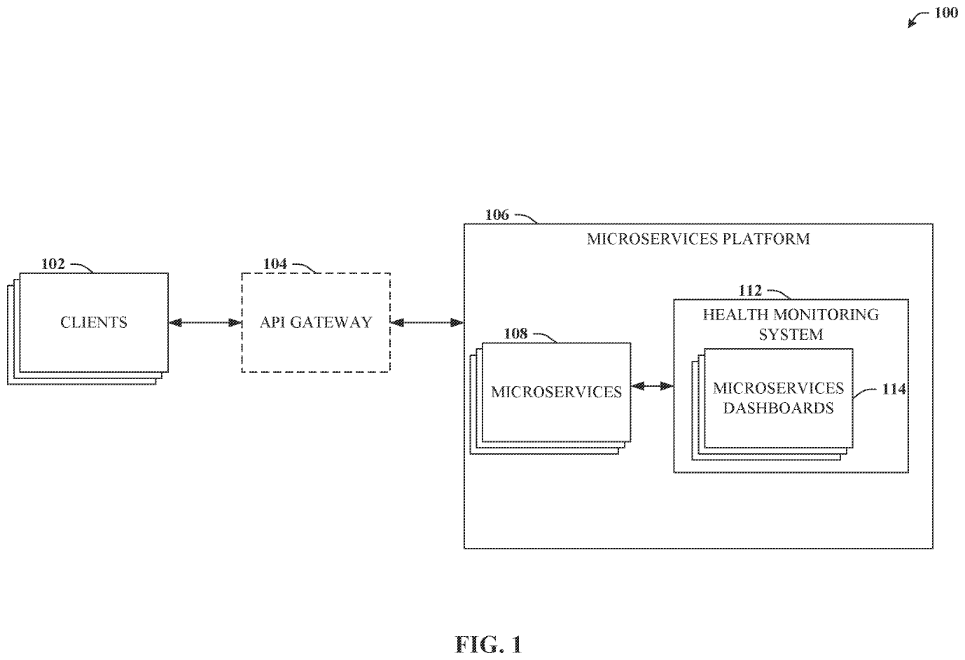

To provide additional context, consider an example architecture associated with a microservices platform, illustrated in connection with FIG. 1. FIG. 1 depicts a schematic block diagram 100 illustrating certain functionality or operation of a microservices platform in accordance with certain embodiments of this disclosure.

Microservices platform 106 can have deployed thereon microservices 108. Microservices 108 can communicate with one another via well-defined application programming interfaces (APIs), such as representational state transfer (REST) APIs. Each microservice 108 can represent a loosely coupled, independently deployable, self-contained service that serves a specific function or capability. Microservices 108 can differ from traditional monolithic applications due to this architectural design. For example, an application can make API calls to one or more microservices 108 instead of coding the function or capability into the application in a monolithic way. Hence, a given microservice 108 can provide a dedicated function or capability to many different applications or other microservices 108 in a more resilient and scalable manner.

For example, clients 102 that execute applications can make calls to microservices 108 of microservices platform 106. Optionally, any such communication can be via API gateway 104. API gateway 104 can be a server that acts as a single entry point for clients 102 to access multiple microservices 108. API gateway 104 can serve as a reverse proxy that routes requests from clients 102 to the appropriate microservices 108, abstracting away potential complexities of the underlying microservices architecture.

It is appreciated that in the context of this disclosure, microservices platform 106 can be any suitable platform that provides access to microservices 108. Such can be any suitable cloud-based services platform, a containerized workflow platform or container orchestration platform such as Kubernetes or another system or platform.

As indicated in the background section, Microservices platforms (e.g., microservices platform 106) can provide developers with the tools and infrastructure needed to build, deploy, and operate microservices-based applications at scale. In order to meet these goals, it can be important to monitor the health of microservices platform 106 as well as the operation of the microservices 108 deployed thereon, which can be provided by health monitoring system 112.

As one example, health monitoring system 112 can comprise a group of microservices dashboards 114. A microservices dashboard 114 can comprise user interface elements that can be configured to present or otherwise report metrics relating to the operation of an associated microservice 108.

To further illustrate, a given microservices dashboard 114 can present elements relating to any of a number of health metrics or elements that are common to the microservices platform 106. Such can include, e.g., hypertext transfer protocol (HTTP) status codes (e.g., number of requests, number of request failures, internal server errors, response time, . . . ), service health, API availability, API latency, and so forth.

Furthermore, microservices dashboard 114 can present custom metrics or elements as well. For example, a given microservices dashboard 114 can be configured in response to a new feature being added to an associated microservice 108 relating to operation of the new feature such as feature flags, feature traffic patterns, errors related to the new feature, and so on.

As another example of a custom metric consider the case in which certain traffic on microservices platform 106 is redirected to a new endpoint. An associated microservices dashboard 114 can be configured to monitor the traffic volume seen by both the new endpoint and the old endpoint in response to t a gradual dial up of traffic over a few days.

Today, microservices dashboards 114 are generated manually, typically by the developers of an associated microservice 108. Building microservices dashboards 114, which can involve designing the service dashboard, identifying the metrics to track or monitor, and setting up alarm thresholds, can take a significant amount of time. Furthermore, the tools utilized to generate microservices dashboards 114 can be different from the tools used to develop microservices 108. Thus, the developers of microservices 108 may be significantly less familiar or entirely unfamiliar with creation of dashboard tools.

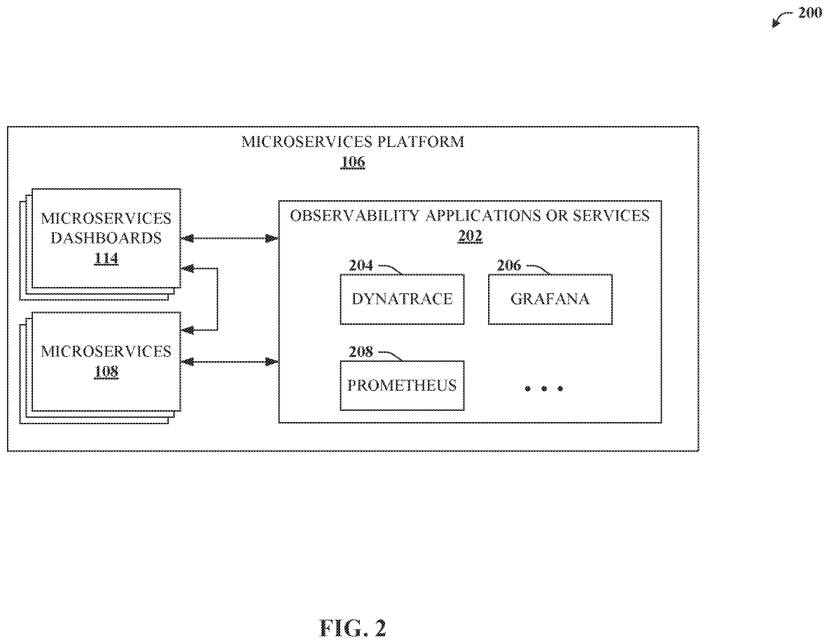

Furthermore, in the case of new feature launch-related dashboards or for other custom metrics (e.g., Prometheus-based counters or gauges), construction of new or updated microservices dashboards 114 can be a frequently occurring task, and one that is expensive in terms of time and effort, which is further detailed in connection with FIG. 2.

Referring now to FIG. 2, a schematic block diagram 200 is depicted illustrating an example architecture for creation of dashboards to monitor operation of microservices in accordance with certain embodiments of this disclosure.

In order to build new microservices dashboards 114, microservices platform 16 can provide access to certain observability applications or services 202. Observability applications or services 202 can represent any suitable application or service that can collect data about the execution, internal state, or communication of microservices 108.

Typically, observability applications or services 202 leverage specific data classes relating to logs, metrics, traces. Logs and traces can be utilized for collecting telemetry data while metrics can be used for measurements or comparisons. While a given microservices platform 106 may potentially use any one or more observability applications or services 202, some representative examples can be Dynatrace 204, Grafana 206, or Prometheus 208. Other examples, of course, can exist.

Dynatrace 204 can be indicative of a Dynatrace product or service comprising a comprehensive observability platform that provides monitoring, analytics, and intelligence for cloud-native environments and applications. The Dynatrace product can be designed to help organizations gain insights into the performance, availability, and health of their applications and infrastructure in real-time. For example, an agent can be injected into an application or microservice 108 in order to monitor metrics or the state of the microservice 108. The Dynatrace product can further comprise visualization functions, which can be leveraged to generate microservices dashboards 114.

Grafana 206 can be indicative of a Grafana product or service. Grafana is an open-source platform for monitoring, visualization, and analytics, which can be utilized in connection with microservices 108. Grafana is commonly used to visualize time series data from various sources, including monitoring systems, databases, and applications.

Prometheus 208 can be indicative of a Prometheus product or service. Prometheus is an open-source monitoring and alerting toolkit designed for monitoring the performance and health of systems and applications such as, e.g., microservices 108. Prometheus is widely used for collecting, storing, querying, and visualizing time-series data. Certain other observability products or services might also be used by a given microservices platform 106 and/or the developers of microservices 108 and might also be representative.

While any suitable observability applications or services 202 can greatly aid developers in the process of creating microservices dashboards 114, said creation is still a manual process. For example, the developer must learn how to adequately use a given observability application or service 202, must manually determine/decide what metrics to track and associated metric alarm thresholds, and potentially other creation or design factors. Hence, the disclosed subject matter that can automatically generate dashboards represents a significant technological improvement because automatically generating these dashboards can significantly reduce the burden on developers and operate to improve the ecosystem of microservices platform 106, which is further detailed below.

### Example Systems

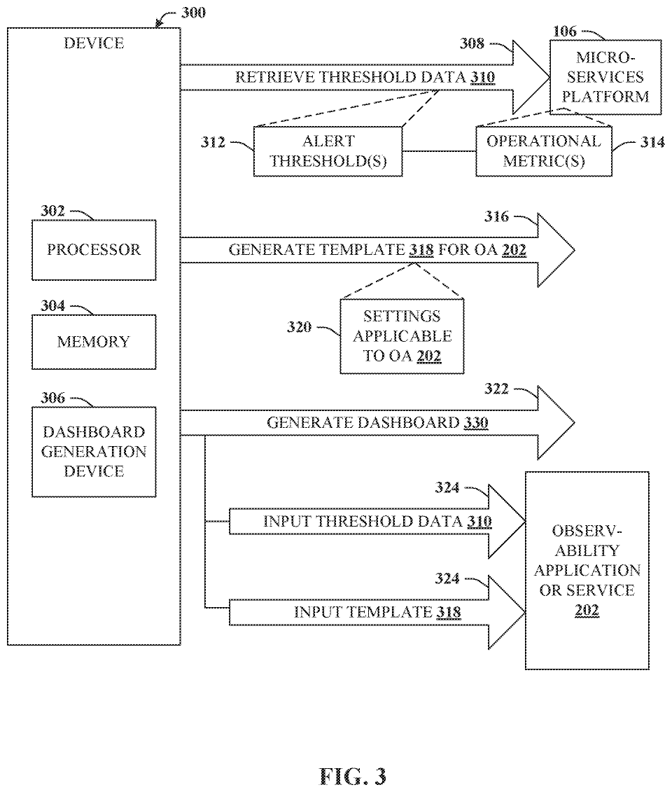

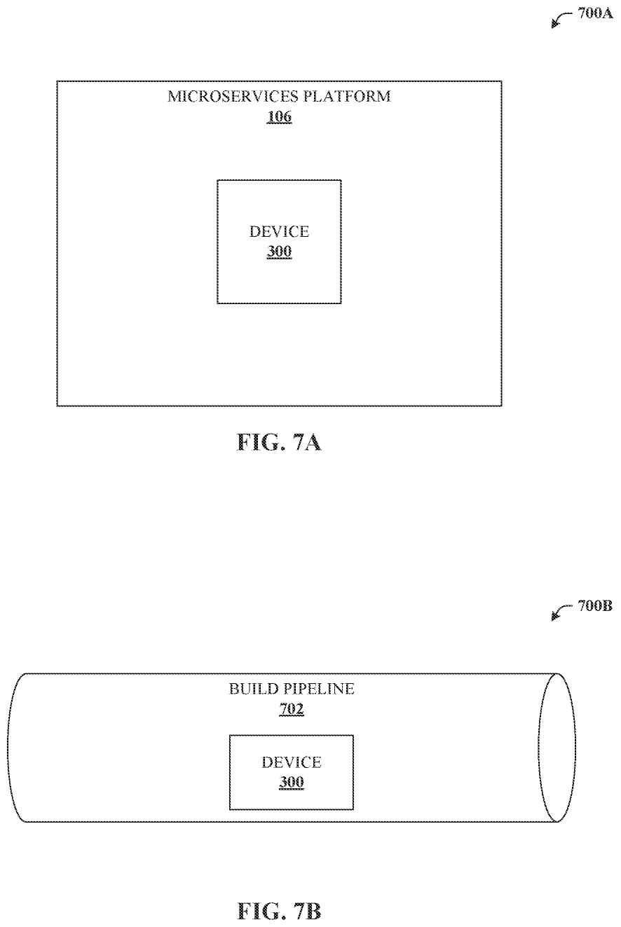

With reference now to FIG. 3, a schematic block diagram is depicted illustrating an example device 300 that can automatically and/or dynamically generate dashboards and alarms for microservices of a microservices platform in accordance with certain embodiments of this disclosure. In some embodiments, device 300 can be in communicatively coupled to a microservices platform such as microservices platform 106. In some embodiments, device 300 can be integrated into a microservices platform, an example of which is illustrated by block diagram 700A of FIG. 7A. In some embodiments, device 300 can be integrated into or included in a build pipeline architecture, an example of which is illustrated by block diagram 700B of FIG. 7B.

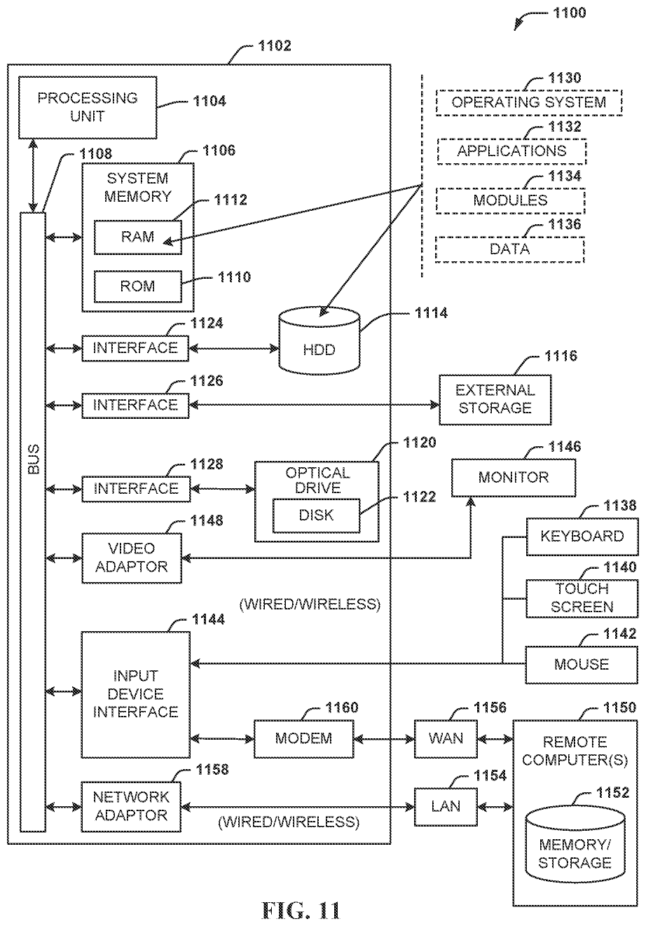

Device 300 can comprise a processor 302 that, potentially along with dashboard generation device 306, can be specifically configured to perform functions associated with generating dashboards for a microservices platform. Device 300 can also comprise memory 304 that stores executable instructions that, when executed by processor 302, can facilitate performance of operations. Processor 302 can be a hardware processor having structural elements known to exist in connection with processing units or circuits, with various operations of processor 302 being represented by functional elements shown in the drawings herein that can require special-purpose instructions, for example, stored in memory 304 and/or dashboard generation device 306. Along with these special-purpose instructions, processor 302 and/or dashboard generation device 306 can be a special-purpose device. Further examples of the memory 304 and processor 302 can be found with reference to FIG. 11. It is to be appreciated that device 300 or computer 1102 can represent a server device or a client device of a network or data services platform and computer 1102 can be used in connection with implementing one or more of the systems, devices, or components shown and described in connection with FIG. 3 and other figures disclosed herein.

As illustrated at reference numeral 308, device 300 can retrieve or otherwise receive threshold data 310. Threshold data 310 can indicate at least one alert threshold 312 for at least one operational metrics 314 of microservices platform 106. In some embodiments, threshold data 310 can be received in response to a microservice (e.g., microservice 108) being deployed via microservices platform 106. Thus, when a new microservice 108, or a new version of microservice 108, is deployed on microservices platform 106, a new or updated dashboard to monitor operation of that new or updated microservice 108 can be generated as detailed herein.

As noted, in some embodiments, device 300 can be incorporated into a build pipeline (e.g., build pipeline 702 of FIG. 7B). Hence, generation of associated dashboards can be integrated into the development process for microservices 108. That is, concurrent with the time of live roll-out of a microservice 108, an associated dashboard configured to monitor the operation of that microservice 108 can be generated with little to no additional burden on the developer of microservice 108, which can represent a significant technical improvement over previous approaches.

As indicated above, threshold data 310 can indicate various alert thresholds 312 for operational metrics 314 of microservices platform 106. For a given operational metric 314 there can be one or more alert thresholds 312, such as a high threshold (e.g., trigger warning), a critical threshold (e.g., trigger pageduty alert), and so forth. Thus, threshold data 310 can be stored to any suitable data structure, with a representative example used herein being a file named alerts.properties.

To provide additional context, consider an example of an alerts.properties file below:
alerts.properties
#Default time window is 5 mins
#critical is pageduty alert
#high is warning
#numbers are in percentages
Error.code=HTTP 5xx,HTTP 4xx
Error.rate.critical=1
Error.rate.high=0.5
#number is drop in percentage, alert if there is a 20% drop in traffic
Request.count.critical=20
Request.count.high=10
#cpu usage percentage to alert or warn
cpu.usage.critical=40
cpu.usage.high=30
#disk usage percentage to alert or warn
disk.usage.critical=40
disk.usage.high=30

As can be observed, certain operational metrics 314 (e.g., HTTP error codes, cpu usage, . . . ) can be identified with associated alert thresholds 312 (e.g., high, critical, . . . ) indicated by threshold data 310, which in this case is embodied as the alert.properites file. It is appreciated that the alert.properties file or other form of threshold data 310 can be stored to microservices platform 106 and/or to device 300, and can be thereafter used (and potentially updated) to aid in the generation of dashboards as further detailed herein.

For example, as indicated at reference numeral 316, device 300 can be configured to generate template 318 based on threshold data 310 (e.g., an alert.properites file). Template 318 can be generated specifically for, or to specifically be applicable to, a given observability application or service 202. Template 318 can comprise one or more settings 320 for user interface elements of a dashboard (e.g., dashboard 330, detailed below) usable to monitor operation of an associated microservice 108 when executing or operating on microservices platform 106. In some embodiments, template 318 can be stored to a template store for later access or recall. As discussed in connection with FIG. 2, observability application or service 202 can be configured to determine a state of microservice 108 and can also include visualization elements that can be leveraged for design or construction of the dashboard, particularly with the use of template 318.

As a representative example, the below represents a Dynatrace (e.g., Dynatrace 204) template:
{
“name”: “5xx errors”,
“tileType”: “DATA_EXPLORER”,
“configured”: true,
“bounds”: {
   “top”: 1406,
   “left”: 0,
   “width”: 304,
   “height”: 304
},
“tileFilter”: { },
“isAutoRefreshDisabled”: false,
“customName”: “Data explorer results”,
“queries”: [
   {
      “id”: “A”,
      “spaceAggregation”: “AUTO”,
      “timeAggregation”: “DEFAULT”,
“metricSelector”:
“builtin:service.errors.fivexx.count:filter(and(inWdt.entity.service\”,entitySelectorWtype(service),entityName(-\“sample-auto-dashboard-*-\”))))):splitBy( )sum:auto:sort(value(sum,descending)):limit(10)”,
“rate”: “NONE”,
“enabled”: true
   }
],
“visualConfig”: {
   “type”: “SINGLE_VALUE”,
   “global”: {
   “hideLegend”: false
   },

As illustrated at reference numeral 322, device 300 can be configured to generate dashboard 330. For example, dashboard 330 can be generated in response to certain input to observability application or service 202. For example, as indicated at reference numeral 324, threshold data 310 can be input to observability application or service 202. As indicated at reference numeral 326, template 318 can also be input to observability application or service 202. With the combination of threshold data 310 and template 318, observability application or service 202 can be leveraged to automate the generation of dashboard 330, which can thereafter be used to monitor the operation of associated microservice(s) 108 that run on microservices platform 106.

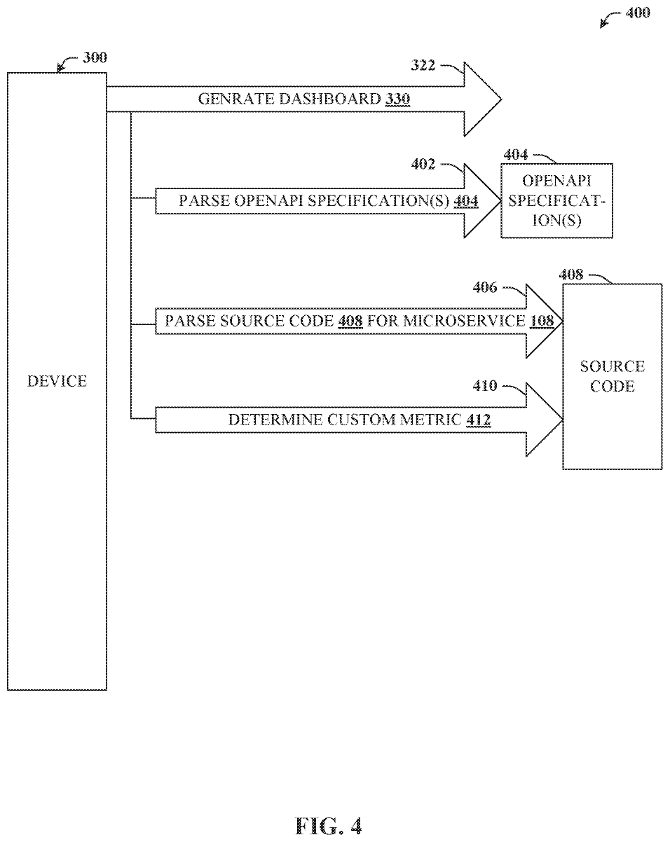

Turning now to FIG. 4, a schematic block diagram 400 is depicted illustrating additional elements or embodiments relating to the generation of the dashboard 330 in accordance with certain embodiments of this disclosure. For example, in some embodiments, as indicated at reference numeral 402, dashboard 330 can be generated in response to parsing an openAPI specification 404.

An openAPI specification is an open standard for describing and documenting RESTful APIs. Typically, the openAPI specification defines a standard, language-agnostic interface for RESTful APIs, allowing developers to understand the capabilities of an API without needing to read associated source code. The OpenAPI specification can provide a standardized and interoperable way to describe and document RESTful APIs, enabling developers to build, integrate, and consume APIs more effectively. The openAPI specification is intended to promote consistency, transparency, and collaboration in API development, making it easier for developers to work with APIs and build innovative applications.

As such, parsing the openAPI specification can be used in this case to identify suitable elements for standard dashboards and threshold data 310 can be used to indicate alert thresholds 312 for operational metrics 314 for the associated standard dashboard. However, the disclosed subject matter is not limited merely to creating standard dashboards (e.g., using common or standard operational metrics 314), but rather can further provide for custom dashboards that use custom metrics and alarms, as further explained below. Hence, it is to be appreciated that dashboard 330 that is automatically generated can be a standard dashboard with standard or commonly used metrics as well as custom dashboards with custom metrics and alarm triggers.

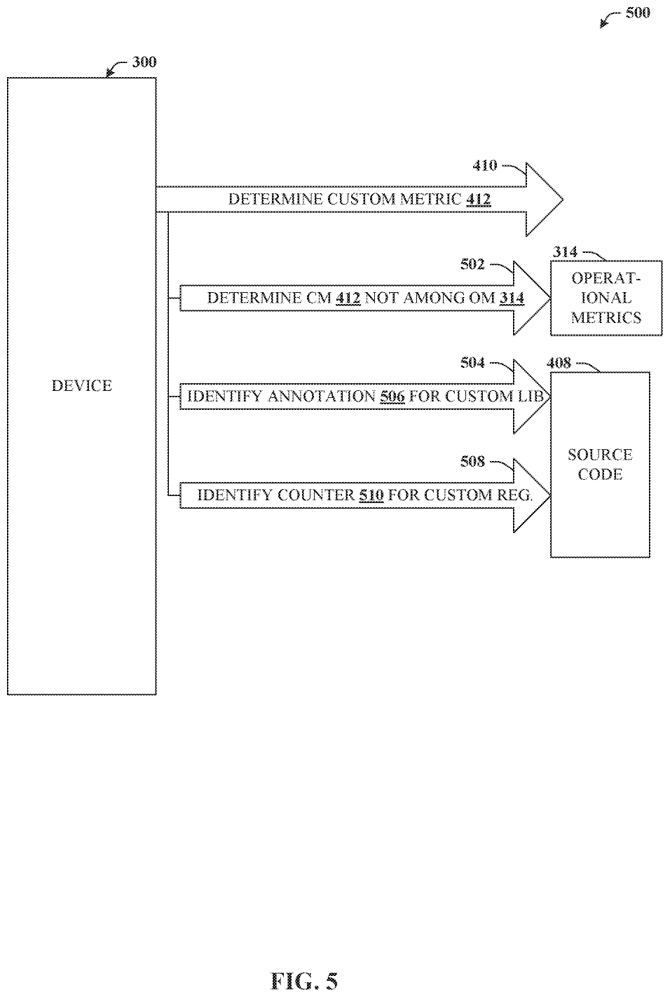

In that regard, as illustrated at reference numeral 406, device 300 can parse source code 408 for an associated microservice 108. Such parsing can be performed at build time such as via a build pipeline 702 process or procedure. As indicated at reference numeral 410, in response to parsing source code 408, device 300 can determine custom metric 412, which is further detailed in connection with FIG. 5. In some embodiments, device 300 can further determine or facilitate determination of alert thresholds associated with the custom metric 412.

Referring now to FIG. 5, a schematic block diagram 500 is depicted illustrating addition elements or embodiments relating to determining a custom metric 412 in accordance with certain embodiments of this disclosure. As indicated at reference numeral 502, a custom metric 412 can be determined as such by virtue of not being among the set of operational metrics 314 of a given microservices platform 106 and/or not being among those identified in threshold data 310.

Generally, custom metric 412 can be identified due to the use of custom libraries (e.g., as opposed to standard libraries) with the source code 408 of a given microservice 108. In other words, source code 408 for a given microservice 108 can be instrumented with certain annotations 506 that are supported by a custom library such as, e.g., a micrometer library, an actuator library, or the like. In addition, metrics like counters 510 or gauges can be coded using a custom library/registry such as MeterRegistry or the like.

Hence, when parsing the source code 408 of a given microservice 108 (e.g., as introduced at reference numeral 406 of FIG. 4), these annotations 506, counters 510, or the like can be specifically identified in order to determine or identify the custom metric 412. Such is illustrated at reference numerals 504 and 508, respectively.

In the context of Java Spring Boot, the below examples are provided. It is understood that other language frameworks can have a similar methodology to support custom metrics to which the disclosed solutions can apply.
@Bean
public Counter (MeterRegistry registry)
{
   return registry.counter(“Requests.Count”);
}

The above bean can be referenced in a class that is to generate the custom metric.
@RestController
public class ExampleController implements ExampleApi {
   @ Autowired
   private Counter requestsCounter;
   @Override
   public ResponseEntity<ExampleModel>getExampleModel( ) {
   ExampleModel model=ExampleModel.builder( ).message(“example is working”).build( )
   requestsCounter.increment( )
   return ResponseEntity.ok(model);
   }
}

Using the actuator and micrometer, or another custom library, custom metrics 412 can be created. The endpoints for these custom metrics 412 and the values to create a metric within the context of observability application or service 202 can be added to configuration files (e.g., alerts.properties, . . . ), which can be scanned in order to create template 318 and/or to properly configure observability application or service 202.

Furthermore, whether dashboard 330 is considered a standard dashboard (e.g., dashboards 330 that do not utilize custom metrics 412) or a custom dashboard, information included in threshold data 310 or elsewhere can be used to provide a list of potential metrics (e.g., operational metrics 314) to be monitored as well as the alert thresholds 312. In some embodiments, such can be leveraged to allow a developer or other entity to select from among the available or recommended operational metrics 314 that will be monitored and presented by dashboard 330. Thus, both standard and custom dashboards 330 can be further tailored based or preference or other factors, if desired.

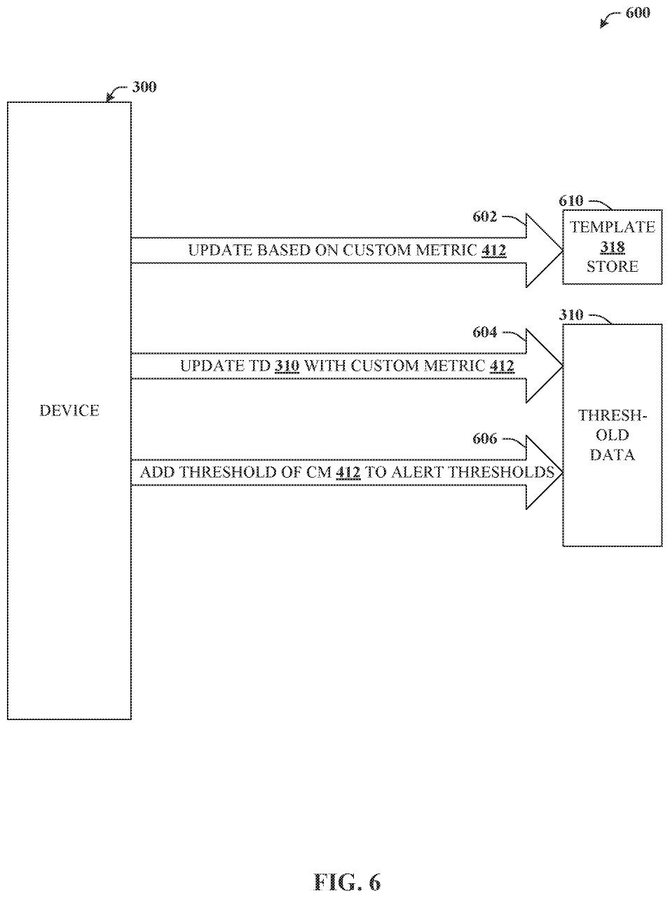

With reference now to FIG. 6, a schematic block diagram 600 is depicted illustrating additional elements or embodiments relating to device 300 that can automatically and/or dynamically generate dashboards and alarms for microservices of a microservices platform in accordance with certain embodiments of this disclosure. As detailed above, certain dashboards 330 can be generated with one or more custom metrics 412, which can also have associated alert thresholds. In that case, the custom metric 412 and associated alert threshold is not likely to be defined in configuration files (e.g., the alerts.properties file, template 318, . . . ) used to generate standard dashboards.

However, as illustrated at reference numeral 602, in some embodiments, device 300 can update template store 610 based on custom metric 412. For instance, a template for the custom metric 412 can be generated, potentially in the manner template 318 was generated. As another example, template 318 can be updated to include support for custom metric 412. In either case, standard dashboards can be subsequently extended (e.g., to define custom metric 412) so that custom metric 412 can be available for all other microservices as part of the standard dashboard.

Likewise, as indicated at reference numeral 604, device 300 can update threshold data 310 with custom metric 412. As indicated at reference numeral 606, device 300 can add a threshold of custom metric 412 to the alert thresholds 314 included in threshold data 310. These updates can further facilitate extending the standard configuration files to include information relating to custom metric 412.

With reference now to FIG. 7A, a schematic block diagram 700A is depicted illustrating an example of device 300 being included in microservices platform 106 in accordance with certain embodiments of this disclosure. FIG. 7B illustrates an example of device 300 being included in a build pipeline 702 in accordance with certain embodiments of this disclosure. Hence, in some embodiments, dashboards 330 can be generated as part of the build process for an associated microservice 108 and/or the build process can trigger the techniques used to automatically generate dashboards 330.

### Example Methods

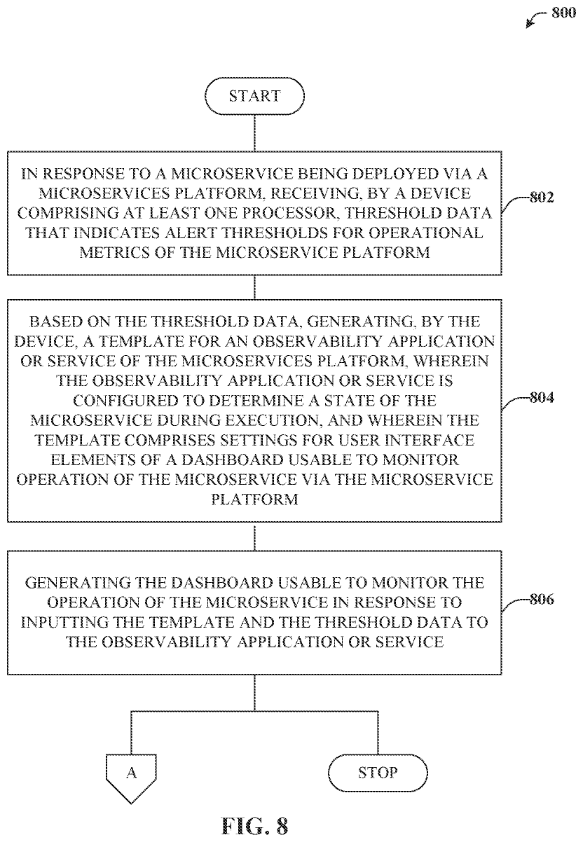

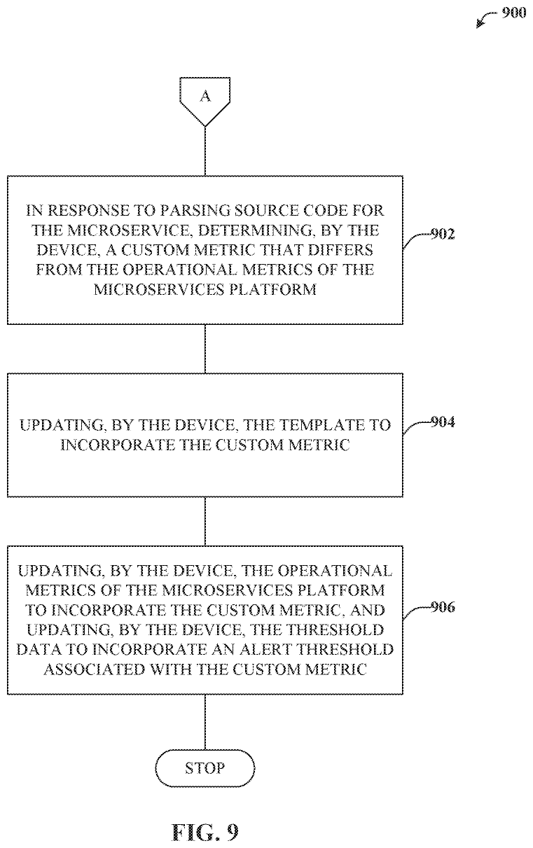

FIGS. 8 and 9 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 8, exemplary method 800 is depicted. Method 800 can automatically and/or dynamically generate dashboards and alarms for microservices of a microservices platform in accordance with certain embodiments of this disclosure. While method 800 describes a complete method, in some embodiments, method 800 can include one or more elements of method 900, as illustrated by insert A.

At reference numeral 802, a device comprising a processor can receive threshold data. In some embodiments, this threshold data can be received in response to a microservice being deployed via a microservices platform. In some embodiments, the threshold data can be received in response to the microservice completing a step or stage of a build pipeline. Regardless, the threshold data can indicate alert thresholds for operational metrics of the microservices platform.

Based on the threshold data received at reference numeral 802, at reference numeral 804, the device can generate a template for an observability application or service of the microservices platform. The observability application or service can be configured to determine a state of the microservice during execution on the microservices platform. The template that is generated based on the threshold data can comprise settings for user interface elements of a dashboard usable to monitor operation of the microservice via the microservice platform. The template can be specifically generated for a specific one or type of observability application or service.

At reference numeral 806, the device can generate the dashboard usable to monitor the operation of the microservice in response to inputting the template and the threshold data to the observability application or service. Method 800 can terminate in some embodiments, or proceed to insert A in other embodiments, which is further detailed in connection with FIG. 9.

Turning now to FIG. 9, exemplary method 900 is depicted. Method 900 can provide for additional functionality or elements relating to generating dashboards and alarms for microservices of a microservices platform in accordance with certain embodiments of this disclosure.

For example, at reference numeral 902, the device introduced in FIG. 8 can further determine a custom metric. The custom metric can be determined in response to parsing source code of an associated microservice. For instance, said parsing can identify annotations or counters that reference custom libraries or registries from which the custom metric can be determined. The custom metric can differ from the operational metrics of the microservices platform that can be used to generate standard dashboards.

A reference numeral 904, the device can update the template to incorporate the custom metric. At reference numeral 906, the device can update the operational metrics of the microservices platform to incorporate the custom metric. Such can be done, e.g., by updating appropriate configuration files or other suitable data structures that store certain information describing the operational metrics. Similarly, the device can update the threshold data to incorporate an alert threshold associated with the custom metric.

### Example Operating Environments

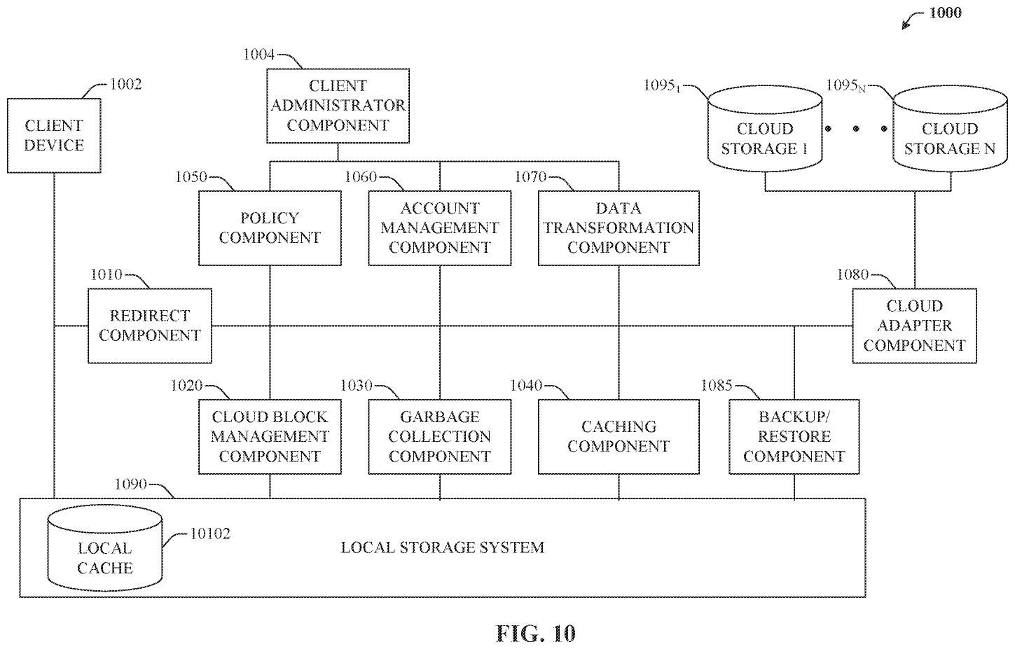

To provide further context for various example embodiments of the subject specification, FIGS. 10 and 11 illustrate, respectively, a block diagram of an example distributed file storage system 1000 that employs tiered cloud storage and block diagram of a computer 1102 operable to execute the disclosed storage architecture in accordance with example embodiments described herein.

Referring now to FIG. 10, there is illustrated an example local storage system including cloud tiering components and a cloud storage location in accordance with implementations of this disclosure. Client device 1002 can access local storage system 1090. Local storage system 1090 can be a node and cluster storage system such as an EMC Isilon Cluster that operates under OneFS operating system. Local storage system 1090 can also store the local cache 1092 for access by other components. It can be appreciated that the systems and methods described herein can run in tandem with other local storage systems as well.

As more fully described below with respect to redirect component 1010, redirect component 1010 can intercept operations directed to stub files. Cloud block management component 1020, garbage collection component 1030, and caching component 1040 may also be in communication with local storage system 1090 directly as depicted in FIG. 10 or through redirect component 1010. A client administrator component 1004 may use an interface to access the policy component 1050 and the account management component 1060 for operations as more fully described below with respect to these components. Data transformation component 1070 can operate to provide encryption and compression to files tiered to cloud storage. Cloud adapter component 1080 can be in communication with cloud storage 1 1095₁ and cloud storage N 1095_{N}, where N is a positive integer. It can be appreciated that multiple cloud storage locations can be used for storage including multiple accounts within a single cloud storage location as more fully described in implementations of this disclosure. Further, a backup/restore component 1085 can be utilized to back up the files stored within the local storage system 1090.

Cloud block management component 1020 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1020 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1060 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1020 based on a list of mappings that the cloud block management component 1020 manages. For example, each stub can be associated with an account, and the cloud block management component 1020 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1080 manages the sending and receiving of data to and from the cloud service providers. The cloud adapter component 1080 can utilize a set of APIs. For example, each cloud service provider may have provider specific API to interact with the provider.

A policy component 1050 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1030. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1030 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1040 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1020, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1040 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1040 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1070 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 1085 can transfer a copy of the files within the local storage system 1090 to another cluster (e.g., target cluster). Further, the backup/restore component 1085 can manage synchronization between the local storage system 1090 and the other cluster, such that, the other cluster is timely updated with new and/or modified content within the local storage system 1090.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various example embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1194 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1194 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
in response to a microservice being deployed via a microservices platform, retrieving threshold data that indicates alert thresholds for operational metrics of the microservice platform;
based on the threshold data, generating a template applicable to an observability application or service of the microservices platform, wherein the template comprises settings for user interface elements of a dashboard usable to monitor operation of the microservice via the microservice platform and wherein the observability application or service is configured to determine a state of the microservice; and
generating the dashboard that is usable to monitor operation of the microservice in response to inputting the template and the threshold data to the observability application or service.

2. The device of claim 1, wherein threshold data is retrieved in response to the microservice being committed to a build pipeline of the microservices platform.

3. The device of claim 1, wherein threshold data and the operational metrics are specific to the microservices platform.

4. The device of claim 1, wherein observability application or service is at least one of a Grafana application or service or a Dynatrace application or service.

5. The device of claim 1, wherein the generating the dashboard further comprises generating the dashboard in response to parsing an openAPI specification.

6. The device of claim 1, wherein the operations further comprise, in response to parsing source code for the microservice, determining a custom metric that is not included among the operational metrics of the microservices platform.

7. The device of claim 6, wherein the custom metric is determined in response to identification, within the source code, of an annotation supported by a custom library.

8. The device of claim 6, wherein the custom metric is a counter determined in response to identification, within the source code, of the counter that is supported by a custom registry.

9. The device of claim 6, wherein the operations further comprise updating the template to incorporate the custom metric.

10. The device of claim 6, wherein the operations further comprise updating the threshold data to incorporate the custom metric with the operational metrics and to incorporate an alert threshold associated with the custom metric to the alert thresholds.

11. A non-transitory computer-readable medium comprising instructions that, in response to execution, cause a system comprising at least one processor to perform operations, comprising:
in response to a microservice being committed to a build pipeline of a microservices platform, retrieving threshold data that indicates alert thresholds for operational metrics applicable to the microservice platform;
based on the threshold data, generating a template for an observability application or service of the microservices platform, wherein the template comprises settings for user interface elements of a dashboard configured for monitoring operation of the microservice on the microservice platform, and wherein the observability application or service is configured to determine a state of the microservice in execution; and
generating the dashboard configured for monitoring operation of the microservice in response to inputting the template, comprising the threshold data, to the observability application or service.

12. The non-transitory computer-readable medium of claim 11, wherein the operations further comprise generating the dashboard in response to parsing an openAPI specification.

13. The non-transitory computer-readable medium of claim 11, wherein the operations further comprise, in response to parsing source code for the microservice, determining a custom metric that is not included among the operational metrics of the microservices platform.

14. The non-transitory computer-readable medium of claim 14, wherein the operations further comprise updating the template to incorporate the custom metric.

15. The non-transitory computer-readable medium of claim 14, wherein the operations further comprise updating the threshold data to incorporate the custom metric with the operational metrics and to incorporate an alert threshold associated with the custom metric to the alert thresholds of the threshold data.

16. The non-transitory computer-readable medium of claim 11, wherein the operations further comprise, during the operation of the microservice, performing an application programming interface call to the observability application or service, and updating a value for an operational metric, of the operational metrics, of the dashboard based on a response to the application programming interface call.

17. A method, comprising:
in response to a microservice being deployed via a microservices platform, receiving, by a device comprising at least one processor, threshold data that indicates alert thresholds for operational metrics of the microservice platform;
based on the threshold data, generating, by the device, a template for an observability application or service of the microservices platform, wherein the observability application or service is configured to determine a state of the microservice during execution, and wherein the template comprises settings for user interface elements of a dashboard usable to monitor operation of the microservice via the microservice platform; and
generating the dashboard usable to monitor the operation of the microservice in response to inputting the template and the threshold data to the observability application or service.

18. The method of claim 17, further comprising, in response to parsing source code for the microservice, determining, by the device, a custom metric that differs from the operational metrics of the microservices platform.

19. The method of claim 18, further comprising updating, by the device, the template to incorporate the custom metric.

20. The method of claim 18, further comprising updating, by the device, the operational metrics of the microservices platform to incorporate the custom metric, and updating, by the device, the threshold data to incorporate an alert threshold associated with the custom metric.
